(19) United States
(12) Patent Application Publication
(10) Pub. No.: US 2014/0083217 A1
(43) Pub. Date: Mar. 27, 2014

(54) RADIALLY RECIPROCATING LOCK

(71) Applicants: MARGARET C. LIU, MERCER ISLAND, WA (US); SAMUEL K. LIU, MERCER ISLAND, WA (US); KAN CUI, SAMMAMISH, WA (US)

(72) Inventors: MARGARET C. LIU, MERCER ISLAND, WA (US); SAMUEL K. LIU, MERCER ISLAND, WA (US); KAN CUI, SAMMAMISH, WA (US)

(21) Appl. No.: 14/022,208

(22) Filed: Sep. 9, 2013

Related U.S. Application Data
(60) Provisional application No. 61/706,642, filed on Sep. 27, 2012.

(51) Int. Cl. F16H 21/22

(52) U.S. Cl. CPC F16H 21/22
USPC 74/44

(57) ABSTRACT

The radially reciprocating lock includes an elongate, hollow cylindrical housing having a locking mechanism disposed therein. The locking mechanism includes an axially extending lock shaft and at least one crank disk attached to the shaft. A recess is formed in at least one end of the lock shaft for insertion of a key or tool to rotate the lock shaft and the crank disk. At least one endcap is provided to securely cover an exposed end of the housing. The endcap includes a center hole for passage of the lock shaft end. At least one locking member is operatively connected to the crank disk to radially reciprocate between an extended, locked position and a retracted, unlocked position through respective slots on the housing. A crank linkage mechanism and a cam mechanism are provided to reciprocate the at least one locking member.

### CROSS-REFERENCE TO RELATED APPLICATION

This application claims the benefit of U.S. Provisional Patent Application Ser. No. 61/706,642, filed Sep. 27, 2012.

### 1. FIELD OF THE INVENTION

The present invention relates to mechanical locks, and particularly to a radially reciprocating lock for easy and secure locking of mechanical components.

### 2. DESCRIPTION OF THE RELATED ART

Many shafts, spindles, joints and pins incorporate keys to lock the same with another mechanical component, such as gears. This insures that the shaft does not dislodge from engagement with the connected mechanical component during movement thereof (e.g., that the gear rotates with the shaft), especially for rotary components. In most instances, the key is a relatively permanent element, both in fit and construction. As components wear or fail, it can be difficult to replace or remove those components from the keyed shaft.

Other mechanical constructions, such as locks that selectively connect parts together, also utilize a type of keyed engagement between the parts. Some examples include simple dead locks, reciprocating locks, and spring locks. These function well, but some tend to be overly complicated or difficult to operate. Others require specialized tools for actuating the locking mechanism. Still others have a narrow range of applications due to design and strength limitations, e.g., biased detents used in telescoping legs.

In light of the above, there is still a need for a relatively simple, durable lock that poses minimal difficulty in the operation thereof and has universal utility. Thus a radially reciprocating lock solving the aforementioned problems is desired.

### SUMMARY OF THE INVENTION

The radially reciprocating lock includes an elongate, hollow, cylindrical housing having a locking mechanism disposed therein. The locking mechanism includes an axially extending lock shaft and at least one crank disk attached to the shaft. A recess is formed on at least one end of the lock shaft for insertion of a key or tool to rotate the lock shaft and the crank disk. At least one endcap is provided to securely cover an exposed end of the housing. The endcap includes a center hole for passage of the lock shaft end. At least one locking member is operatively connected to the crank disk to radially reciprocate between an extended, locked position and a retracted, unlocked position through respective slots on the housing. A crank linkage mechanism and a cam mechanism are provided to reciprocate the at least one locking member.

These and other features of the present invention will become readily apparent upon further review of the following specification and drawings.

### BRIEF DESCRIPTION OF THE DRAWINGS

FIG. 1 is an environmental, perspective view of a radially reciprocating lock according to the present invention.

FIG. 2 is a perspective view of the radially reciprocating lock of FIG. 1.

FIG. 3 is an exploded view of the radially reciprocating lock of FIG. 1.

FIG. 4 is a perspective view of the radially reciprocating lock of FIG. 1, shown broken away and partially in section to show details thereof.

FIG. 5 is a diagrammatic end view of the radially reciprocating lock of FIG. 1, shown broken away and in section to show details of the crank mechanism.

FIG. 6 is a perspective view of an alternative embodiment of a radially reciprocating lock according to the present invention.

FIG. 7 is a perspective view of the radially reciprocating lock of FIG. 6, shown broken away and partially in section to show details thereof.

FIG. 8 is a perspective view of another alternative embodiment of a radially reciprocating lock according to the present invention.

FIG. 9 is a perspective view of the radially reciprocating lock of FIG. 8, shown broken away and partially in section to show details thereof.

FIG. 10A is a perspective view of the crank mechanism of the radially reciprocating lock of FIG. 8, shown in the release position.

FIG. 10B is a perspective view of the crank mechanism of the radially reciprocating lock of FIG. 8, shown in the lock position.

FIG. 11 is a perspective view of a further alternative embodiment of a radially reciprocating lock according to the present invention having a biasing mechanism, shown with the end cap exploded therefrom.

FIG. 12 is a perspective view of a still further alternative embodiment of a radially reciprocating lock having a biasing mechanism according to the present invention, shown with the end cap exploded therefrom.

FIG. 13 is a perspective view of a still further alternative embodiment of radially reciprocating lock according to the present invention.

FIG. 14 is a perspective view of the radially reciprocating lock of FIG. 13, shown with the housing removed to show details of the locking mechanism.

FIG. 15 is a partial environmental perspective view of the radially reciprocating lock of FIG. 13.

FIG. 16 is a schematic end view of a still further alternative embodiment of a radially reciprocating lock according to the present invention.

Similar reference characters denote corresponding features consistently throughout the attached drawings.

### DETAILED DESCRIPTION OF THE PREFERRED EMBODIMENTS

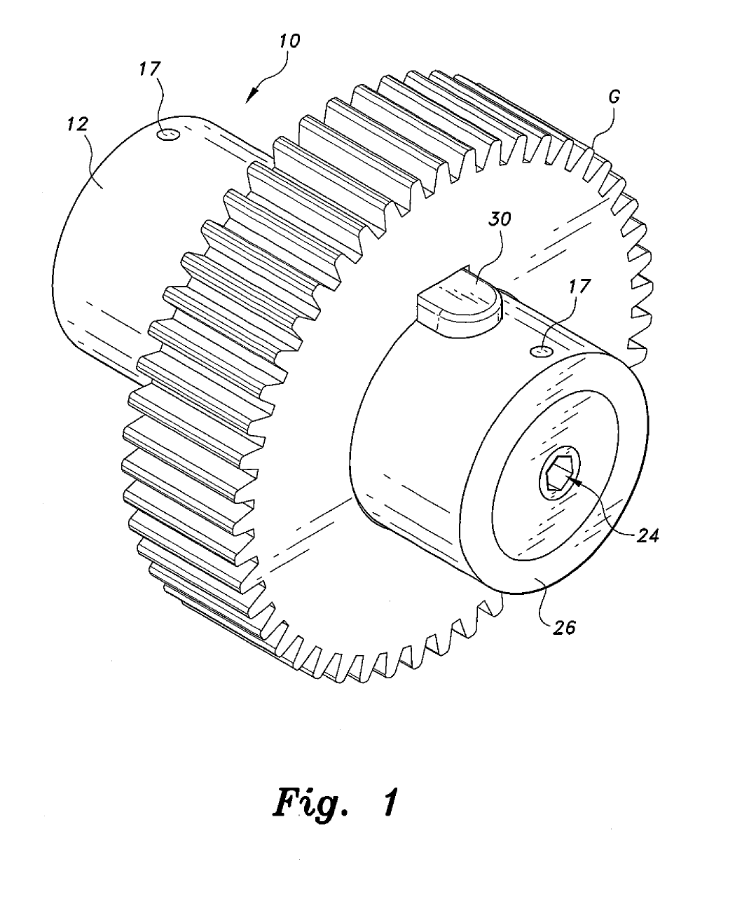

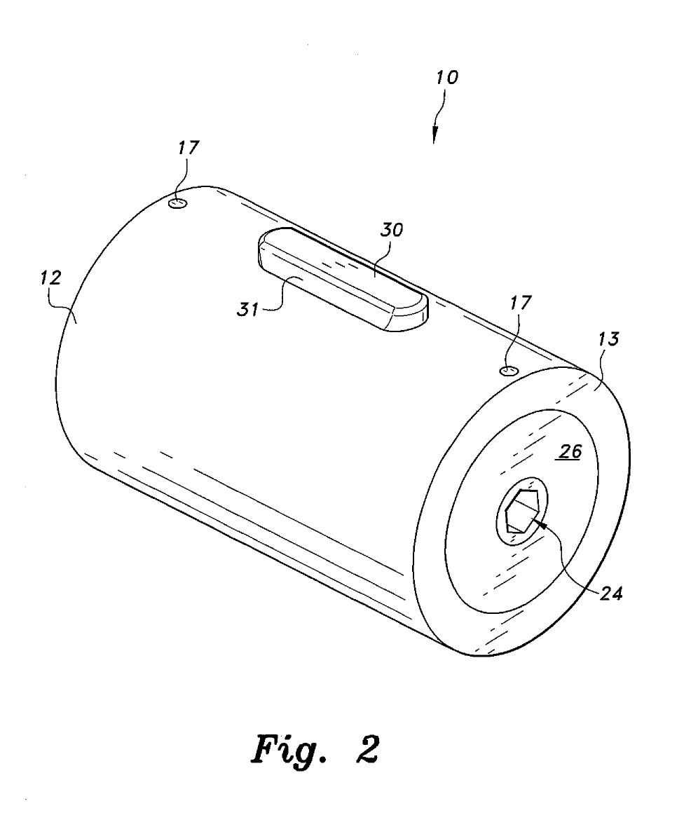

The radially reciprocating lock, a first embodiment of which is referred to by the reference number 10 in FIGS. 1 through 5, provides a secure, releasable locking engagement between separate components. In the embodiment shown in FIGS. 1-5, the radially reciprocating lock 10 is configured as a shaft for detachably mounting a gear G thereon. As mentioned above, it is to be understood that the first embodiment of the radially reciprocating lock 10, and any of the other embodiments to be described herein, can be used in any application requiring releasable locks, such as pivot pins, latches, holders for replaceable parts, and the like.

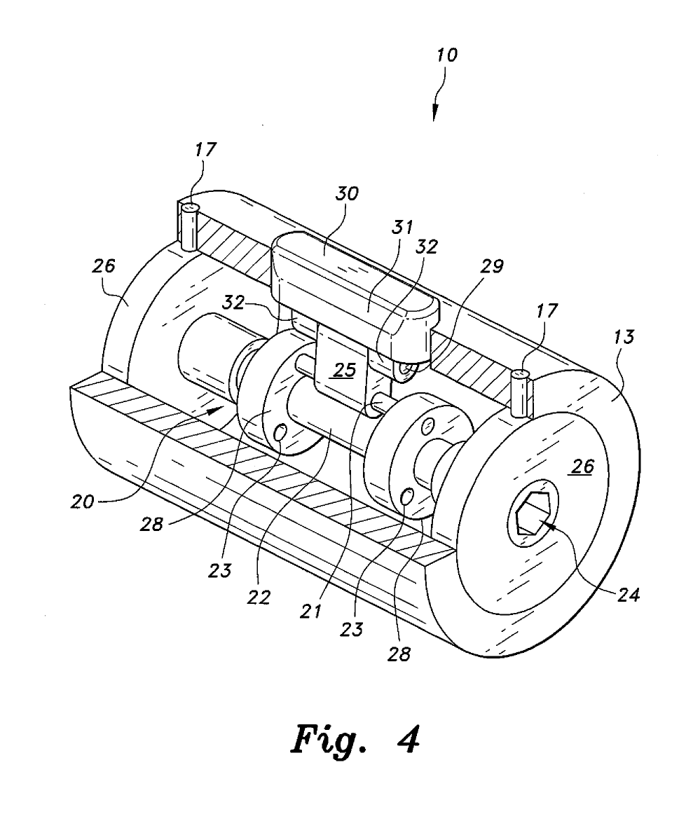

As best seen in FIGS. 1-5, the radially reciprocating lock 10 includes a component 12 that may be referred to as an elongate shaft, pin, rod or cylindrical housing and that is configured for insertion into a mechanical component or base. The housing 12 is preferably hollow, retaining a radially locking mechanism 20 therein, as shown in FIG. 4. An axially extending bore 16 forms the hollow interior of the housing 12.

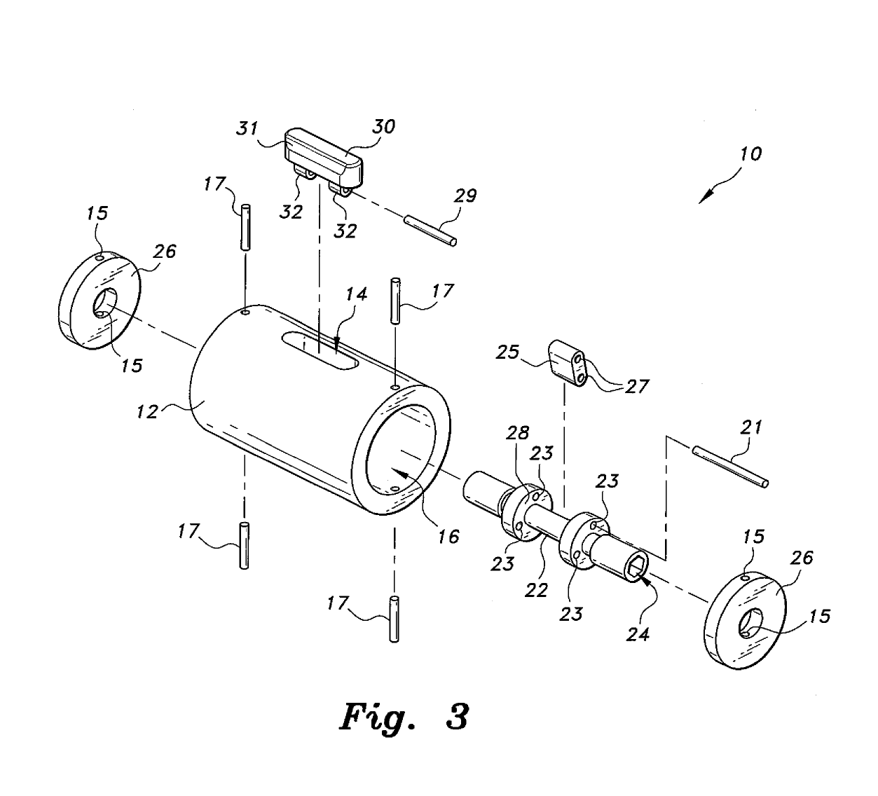

Referring to FIGS. 3 and 4, the locking mechanism 20 includes an elongate lock shaft 22 extending along the axial length of the housing 12 within the axial bore 16. An endcap 26 is attached to each end of the lock shaft 22 so that when assembled, the locking mechanism 20 is encased within the housing 12 and protected from the elements. Each endcap 24 includes a center hole for passage and access of the lock shaft 22. Preferably, the endcaps 26 are flush with the end face 13 of the housing 12 facilitating a tight fit that prevents debris from entering into the interior. One or both ends of the lock shaft 22 include a recess or keyhole 24 for selectively receiving a key or a tool therein. In this exemplary embodiment, the recess 24 is configured to receive a hex-head or Allen wrench tool. Once inserted, the key or tool facilitates rotation of the lock shaft 22. The recess 24 can be provided in a large diameter boss component, as shown. Alternatively, the boss can be of the same diameter as the remainder of the lock shaft 22, or may be constructed with disparate diameter sections, one section being the same diameter as the hole in each endcap 26 and the other section being of larger diameter in order to form an abutment against the back side of the respective end cap 26, thereby preventing the lock shaft 22 from unintentional axial movement out of the housing 12.

As an alternative to the above-described configuration, one or both of the endcaps 26 can protrude past the plane of the end face 13 and/or have a larger diameter for easier access to the recess 24. Although not shown, an O-ring can be provided between the interior diameter of the bore 16 and the rim of the end caps 26 to seal the end openings of the bore 16 and further secure the mounting of the endcaps 26 therein. In this embodiment, it is more preferred to utilize lock pins or dowels 17 for insertion into aligned lock apertures 15 in the end caps 26 and the housing 12. This arrangement securely attaches the endcaps 26 to the housing 12 and prevents the endcaps 26 from rotating therein.

The locking mechanism 20 includes a pair of spaced crank or cam disks 28 mounted along the length of the lock shaft 22. The crank disks 28 each include at least one bore or hole 23 disposed at a position radially offset from the axis of the crank disk 28. The bores 23 support an elongate crank pin 21 therebetween, the crank pin 21 being supported by the disks 28 parallel to the lock shaft 22. One end of a crank arm, link, or member 25 is rotatably mounted to the crank pin 21. The crank arm 25 can also be referred to as a connecting rod, link or member. The crank arm 25 may be configured as an extruded oblong member having lateral bores 27 extending axially through the arm 25. As shown most clearly in FIG. 4, the crank pin 21 extends through one of the bores 27, and the crank arm 25 is also pivotally connected to a locking member 30 via a pivot pin 29 that extends through the other bore 27.

The locking member 30 may be configured as an elongate oblong block having a pair of lugs 32 depending from the bottom thereof. The lugs 32 straddle the opposite ends of the crank arm 25, and the pivot pin 29 is inserted through the bores in the lugs 32 and one of the lateral bores 27 in the crank arm 25. A slot 14 is formed on the housing 12 having the same shape as the locking member 30. The slot 14 defines a passage that restricts the movement of the locking member 30 into and out of the housing 12 in the radial direction. One or more sides of the locking member 30 can be provided with a sloping face 31 that allows easy radial reciprocation of the locking member 30 in the slot 14.

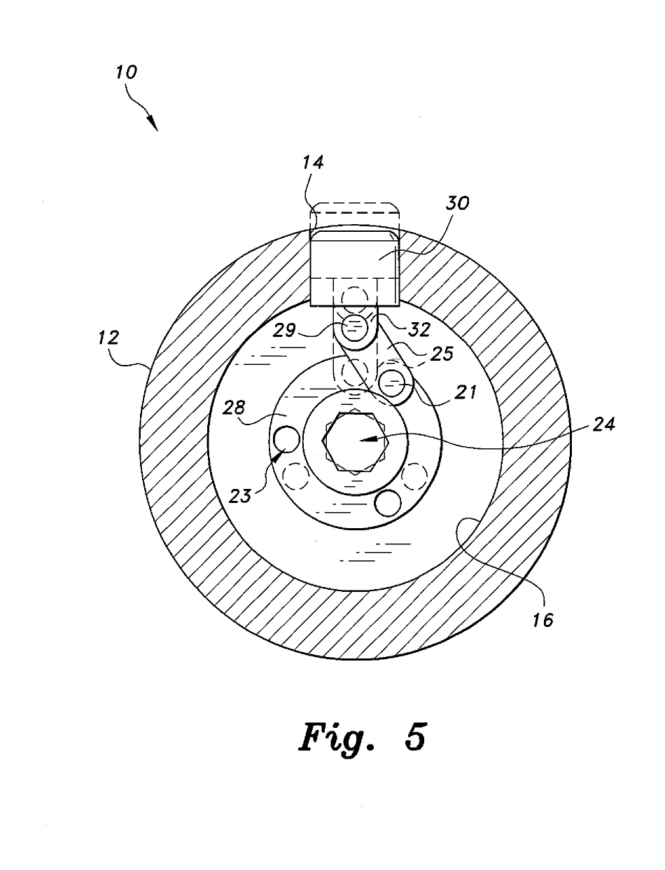

In use, the user inserts a key or tool into the recess 24 on one of the endcaps 26 and turns the tool, thereby rotating the lock shaft 22. From a retracted, unlocked position of the locking member 30, rotation of the lock shaft 22 in either direction over a certain degree of arc correspondingly pivots the crank arm 25. Due to the pivoted connection with the locking member 30, pivoting of the crank arm 25 pushes or reciprocates the locking member 30 in the passage in the slot 14, similar to a piston in an internal combustion engine, thereby extending the locking member 30 out of the housing 12 into the locked position. Preferably, referring to FIG. 5, full extension of the locking member 30 is achieved when the locking member 30 and the crank arm 25 are aligned in a plane extending diametrically through the elongated central axis of the housing 12. The portion of the crank arm 25 extending exterior to the housing 12 forms a shaft key. In the unlocked position, no portion of the crank arm 25 extends exterior of the housing 12, permitting free rotation of the housing 12. Indicia (not shown), such as printed, imprinted, raised, embedded or adhered markings, can be provided on the exposed surface of the area around the recess 24, the endcaps 26 and/or the end face 13 of the housing 12 as a visual guide for proper alignment of the rotated position of the locking shaft 22 corresponding to the extended/locked and retracted/unlocked positions of the locking member 30.

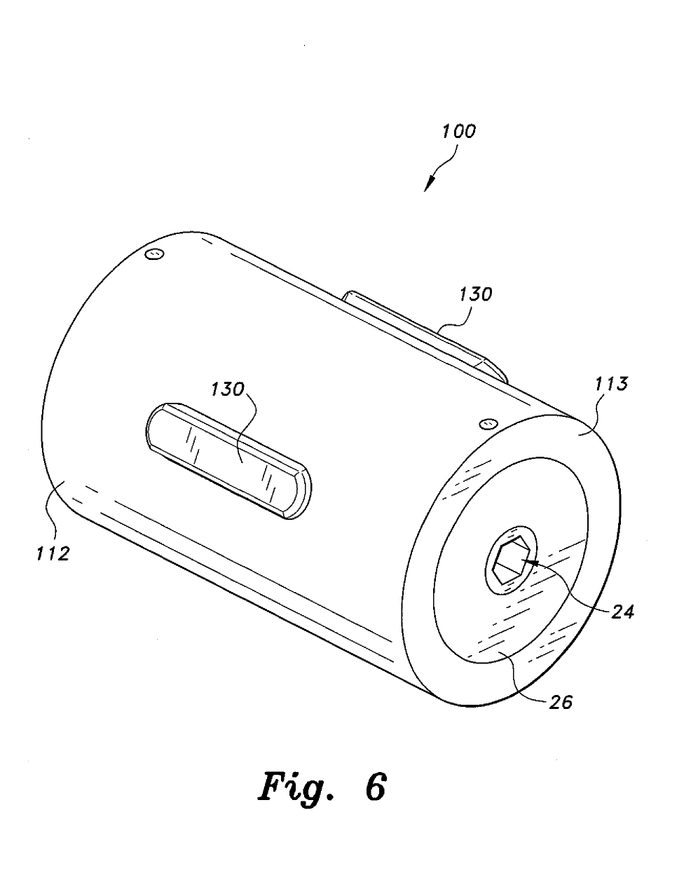

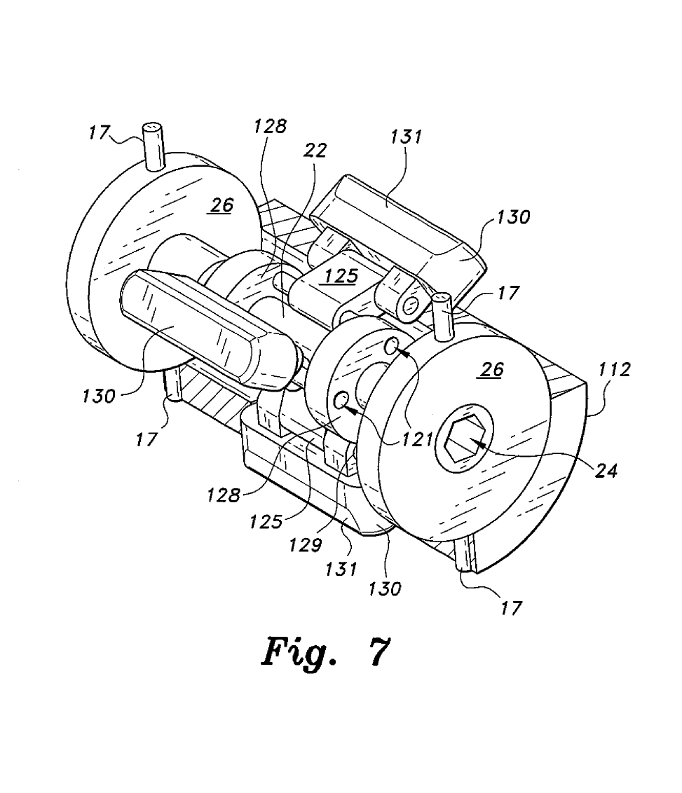

An alternative embodiment of a radially reciprocating lock 100 is shown in FIGS. 6 and 7. In this embodiment, the radially reciprocating lock 100 includes a plurality of radially reciprocating locking members 130 angularly spaced around the housing 112. The construction of the radially reciprocating lock 100 is substantially the same as that of the single locking member embodiment of the radially reciprocating lock 10. Thus, mainly the modifications will be referenced with different reference numbers.

As shown in FIG. 7, the radially reciprocating lock 100 includes a plurality of crank pins 121 equidistantly spaced and supported on the crank disks 128 around the lock shaft 22. Each crank pin 121 extends through one bore of a respective crank arm 125, pivotally attaching the crank arms 25 to the shaft 22, and a pivot pin 129 extends through the other bore of the respective crank arm 125 and the locking member lugs, pivotally attaching the locking members to the crank arms 125. Each of the locking members 130 can also be provided with a sloping face 131, as with the radially reciprocating lock 10.

In use, rotation of the lock shaft 22 via a tool or key inserted into the recess 24 causes radially reciprocating movement of the locking members 130 into and out of the housing 112 corresponding to the unlocked and locked positions of the radially reciprocating lock 100. The plurality of locking members 130 provides a very secure locking engagement at multiple points with respect to connected mechanical components. Moreover, the plurality of locking members 130 provides redundant backup for added insurance in case of mechanical failure of one of the locking members 130. Furthermore, the plurality of locking members 130 permits multiple components to be locked around the housing 112.

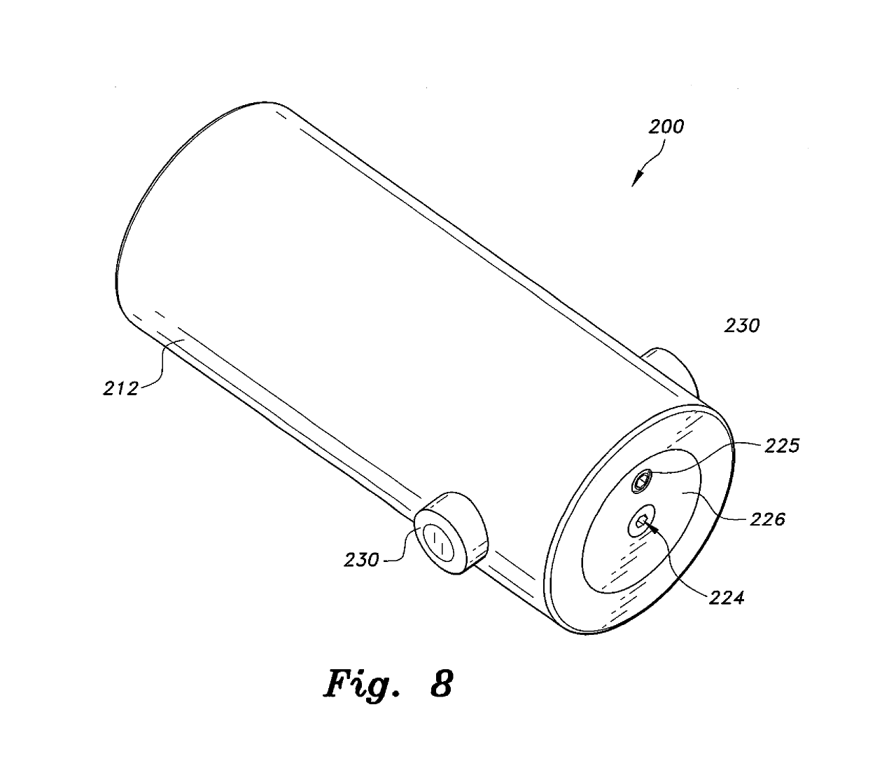

A further alternative embodiment of the radially reciprocating lock 200 is shown in FIGS. 8-10B. This embodiment is relatively simpler in construction compared to the previous embodiment described above, and more reliable due to the smaller number of parts experiencing potential failure.

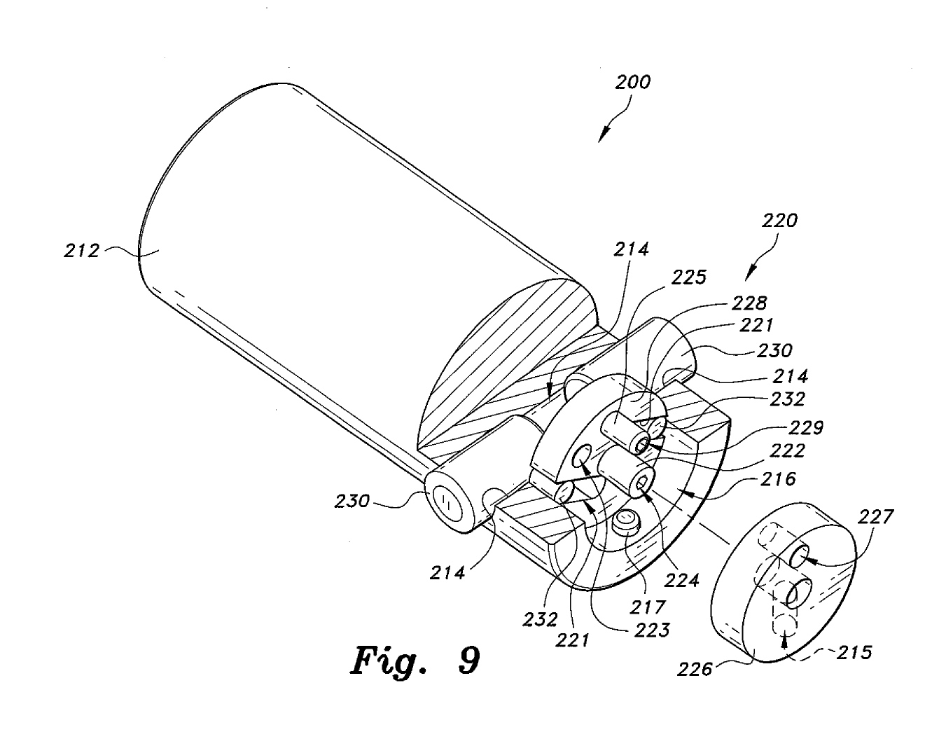

As best seen in FIG. 9, the radially reciprocating lock 200 includes an elongate shaft, pin, rod or cylindrical housing 212, which is configured for insertion into a mechanical component or base. One end section of the housing 212 includes a hollow interior formed by an axial bore 216 extending at least partially into the housing 212. The opening of this bore 216 is capped by an end cap 226, which is secured therein by at least one lock pin or dowel 217 inserted through the housing 212 into a radial lock aperture 215 (which extends radially from the edge of the end cap 226 to the center bore in the end cap 226) in the end cap 226. The endcap 226 also includes a hole for passage and access to a lock shaft 222.

The locking mechanism 220 includes the elongate lock shaft 222 having a crank disk 228 rigidly attached thereto. The crank disk 228 is sized to fit and rotate inside the bore 216 in the housing 212. A recess or keyhole 224 is formed at the end of the lock shaft 222 for selectively receiving a key or a tool therein. In this embodiment, the recess 224 is configured to receive a hex-head tool or Allen wrench.

The locking function is facilitated by a pair of locking members 230 slidably mounted inside a bore 214 extending transversely through the housing 212. Radial extension and retraction of the locking members 230 correspond to locked and unlocked positions of the locking members 230. In this embodiment, the locking members 230 are constructed as elongate, cylindrical posts sized to completely retract within the housing 212 in the bore 214. It is to be noted that the locking members 230 can be constructed in any cross-sectional shape. An elongate cam follower, post or bar 232 extends orthogonally from one end of each locking member 230. The cam followers 232 are configured to slide within cam slots 221 upon rotation of the crank disk 228. In this embodiment, the cam slots 221 extend in a chordal line, rather than a radial line. It is noted that the cam slots 221 can be configured with any cam profile to facilitate the extension or retraction of the locking members 230, and particularly that the cam slots 221 may be straight (linear) or curved (arcuate).

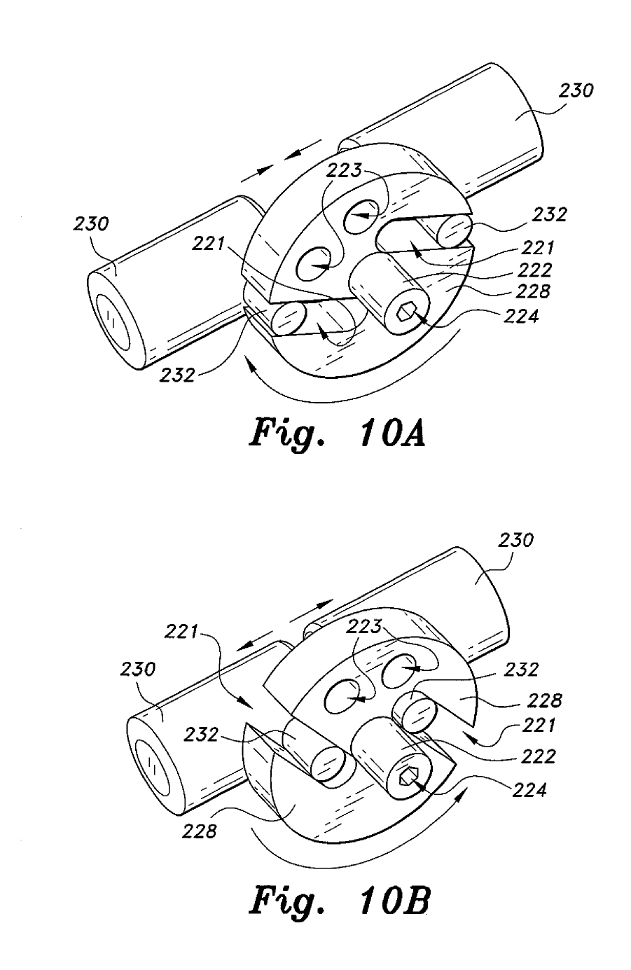

As best seen in FIGS. 10A and 10B, the user inserts a key or tool in the recess 224 to selectively turn or rotate the crank disk 228 in either rotational direction. This, in turn, forces the cam followers 232 to slide within the cam slots 221 thereby reciprocating the locking members 230 within the slot 214 between the locked position shown in FIG. 10A and the unlocked position shown in FIG. 10B. In the locked position, the locking members 230 extend exterior to the housing 212, while in the unlocked position, the locking members 230 are retracted within the housing 212.

The above features and functions of the radially reciprocating lock 200 work well in most situations, but in some instances, it may be necessary to positively lock the extended or retracted positions of the locking members 230. Therefore, the radially reciprocating lock 200 can include at least a pair of position-locking holes 223 disposed on the crank disk 228 and a selectively insertable position locking pin 225. The position-locking holes 223 are angularly spaced and offset from the axis of the crank disk 228. The positions of the position-locking holes 223 correspond to the rotated positions of the crank disk 228 for maintaining either the extended or the retracted positions of the locking members 230. Once either position has been reached, the user inserts the locking pin 225 through a lock hole 227 in the endcap 226 into one of the locking holes 223 aligned with the lock hole 227. Since the endcap 226 is stationary with respect to the rotatable crank disk 228, the aligned holes 223, 227 provide a positive and visual indication that the desired positions have been reached. The inserted locking pin 225 prevents any further rotation of the crank disk 228. The locking pin 225 can be threaded to match internal threads in the locking holes 223 and/or the lock hole 227 for positive installation of the locking pin 225. The locking pin 225 can also include a tool recess 229 to facilitate selective tightening or loosening of the same.

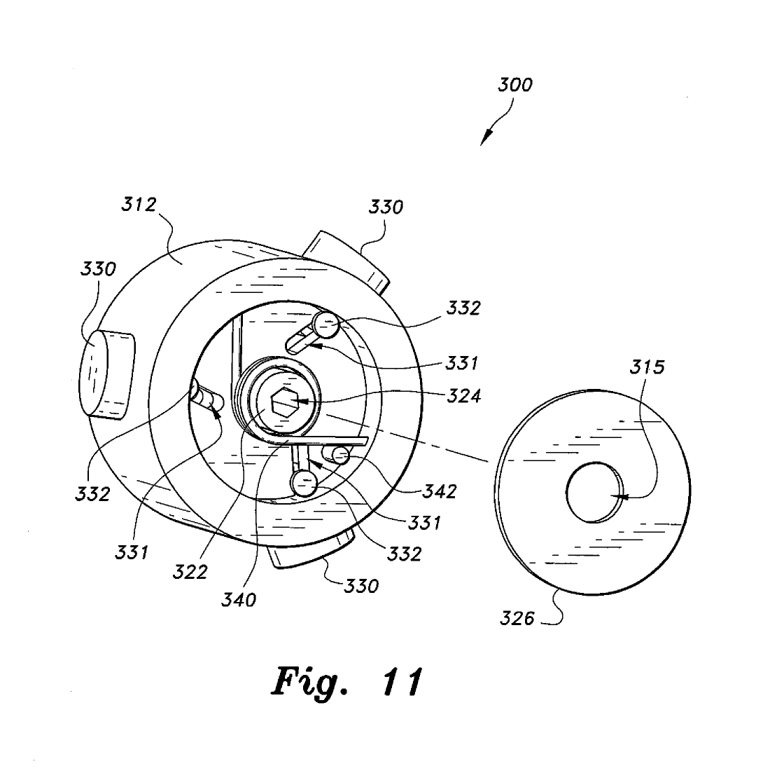

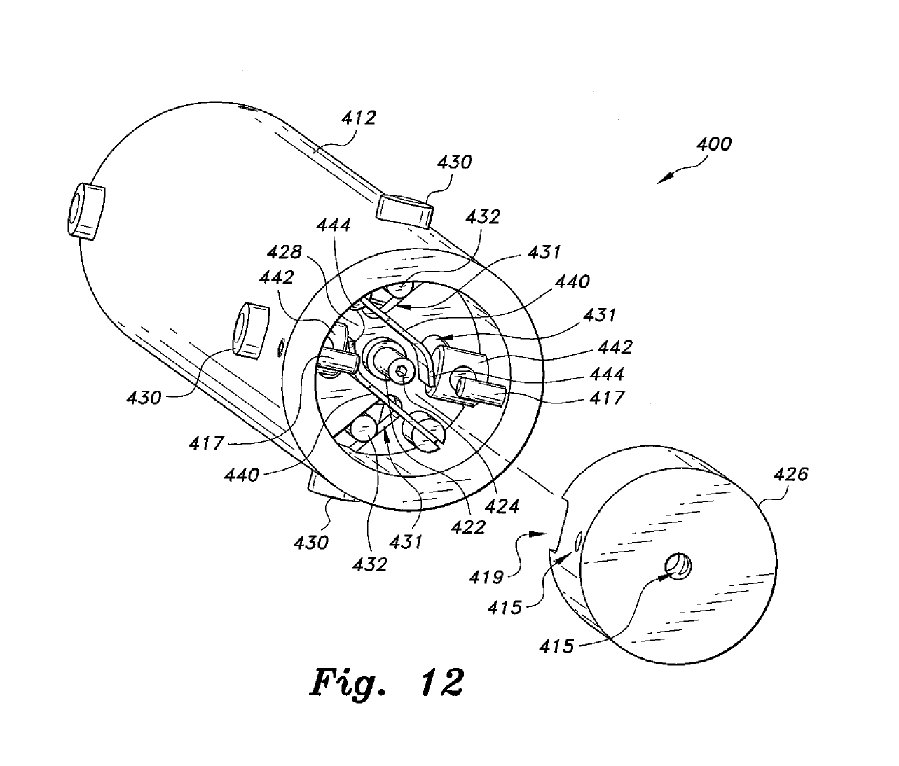

Referring to FIGS. 11 and 12, the drawings disclose alternative embodiments of a radially reciprocating lock having spring-biased locked positions of the respective locking members. In the embodiment shown in FIG. 11, the radially reciprocating lock 300 includes an elongate cylindrical housing 312, a plurality of extendable locking members 330 selectively extended and retracted by rotation of a crank disk 328 with a key or tool in the recess 324 on the lock shaft 322, a cam follower 332 riding inside respective cam slots 331, and an endcap 326 having a center hole 315 for the lock shaft 322. Apart from the additional locking member 320, the radially reciprocating lock 300 function the same as the radially reciprocating lock 200 during use. For added security of engagement, each cam follower 332 can include an enlarged head, preventing accidental axial slip of the cam follower 332 once installed in the respective cam slots 315.

Additionally, the radially reciprocating lock 300 includes a coiled spring 340 wrapped around the lock shaft 322. The coiled spring 340 includes end extensions, one extension being braced against the interior wall of the housing 312 and the other extension being braced against a stop post 342 disposed on the crank disk 328. This arrangement of the coiled spring 340 biases the locking members 330 into the extended, locked position. To unlock, the user simply rotates the crank disk 328 counter to the bias of the coiled spring 340, thereby retracting the locking members 330. The locking members 330 will spring back into the locked position upon release of the unlocking torque on the crank disk 328.

In the embodiment shown in FIG. 12, the radially reciprocating lock 400 includes an elongate cylindrical housing 412, a plurality of extendable locking members 430 selectively extended and retracted by rotation of a crank disk 428 with a key or tool in the recess 424 on the lock shaft 422, a cam follower 432 riding inside respective cam slots 431, and an endcap 426 having a center hole for the lock shaft 422. A plurality of lock pins 417 can be inserted through the housing 412 and into the lock holes 415 in the endcap 426 for securely mounting the same. The radially reciprocating lock 400 functions the same as the radially reciprocating lock 300 during use, but includes four extendable locking members 430.

Additionally, the radially reciprocating lock 400 includes a plurality of leaf springs 440 for biasing the locking members 430 into the extended, locked position. Each leaf spring includes one end rigidly attached to the crank disk 428 and an opposite, free end 444. The free end 444 is braced against a stop post 442 attached to the interior wall of the housing 412. Due to the space occupied by the stop posts 442, the endcap 426 can include a grooved section 419 to accommodate the stop posts 442 when assembled. To unlock, the user simply rotates the crank disk 428 counter to the bias of the leaf springs 440 thereby retracting the locking members 430. The locking members 430 will spring back into the locked position upon release of the unlocking torque on the crank disk 428.

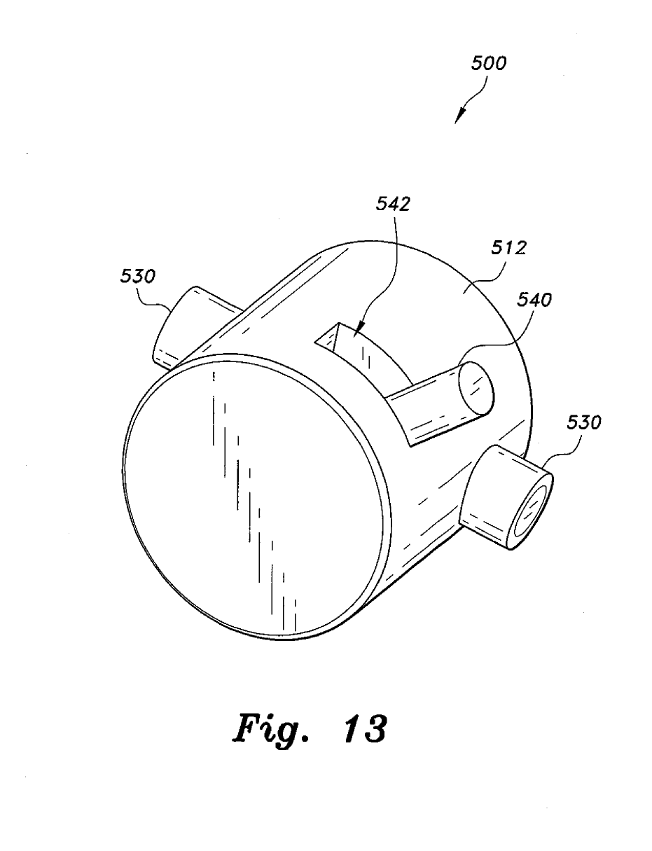

A further alternative embodiment of a radially reciprocating lock 500 is shown in FIGS. 13-15. This embodiment shows an alternative actuating mechanism for selective locking that can be accessed from the side of the housing, rather than from the axial end, as in the previous embodiments.

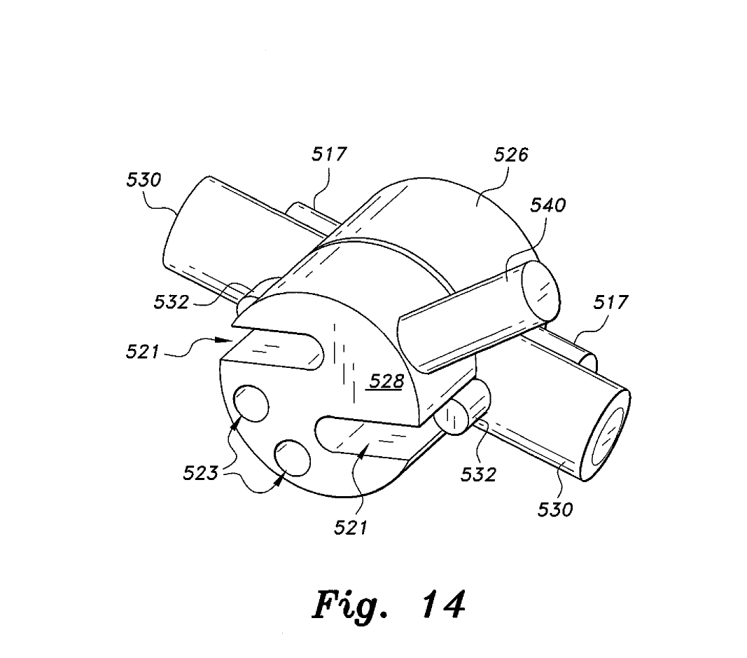

As best seen in FIGS. 13 and 14, the radially reciprocating lock 500 is substantially the same in construction as the radially reciprocating lock 200. The radially reciprocating lock 500 includes a cylindrical housing 512, extendable locking members 530 selectively extended and retracted by rotation of a crank disk 528, a cam follower 532 attached to each locking member 530 and riding inside cam slots 521, and a plurality of locking holes 523 for selective locking of the rotated positions of the crank disk 528. An endcap 526 is disposed behind the crank disk 528 and includes an elongate slot (similar to the elongate slot 214), permitting sliding movement of the locking members 530. The endcap 526 can be secured to the housing by lock pins 517.

In contrast to the previous embodiments, the radially reciprocating lock 500 includes an elongate lever or handle 540 extending radially from the circumferential side of the crank disk 528. In this embodiment, the lever 540 is constructed as an elongate, circular post. It is to be realized that any geometric shape can be used in construction of the lever 540. Instead of the tool or key recess in the previous embodiments, the user can manipulate the lever 540 in an arc in order to turn the crank disk 528. The lever 540 extends out of an arcuate slot 542 in the housing 512. The length of the arcuate slot 542 defines and limits the movement of the lever 540 between locked and unlocked positions.

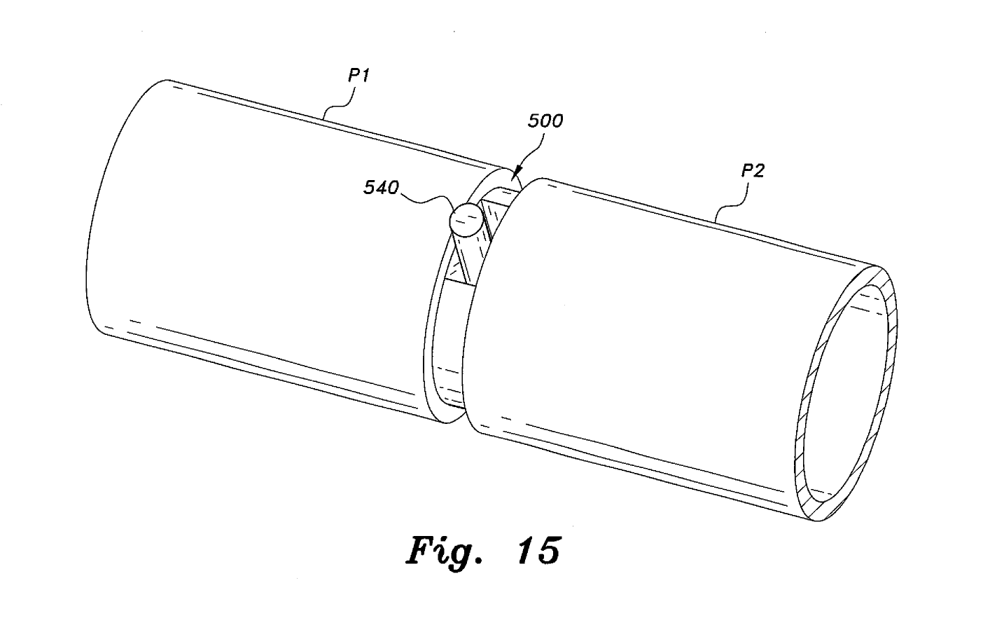

The lever 540 permits the locking and unlocking actuation of the radially reciprocating lock 500 from the side, rather than the axial end. This is particularly effective in securely connecting ends of pipes or the like, as best seen in FIG. 15. As shown, one end of the radially reciprocating lock 500 is securely mounted to an end of a first pipe P1. The end of a second pipe P2 can be mounted the other end of the radially reciprocating lock 500 and locked in place by manipulating the lever 500 into the locked position. The second pipe P2 can be dismounted by reversing the manipulation of the lever 540 into the unlocked position.

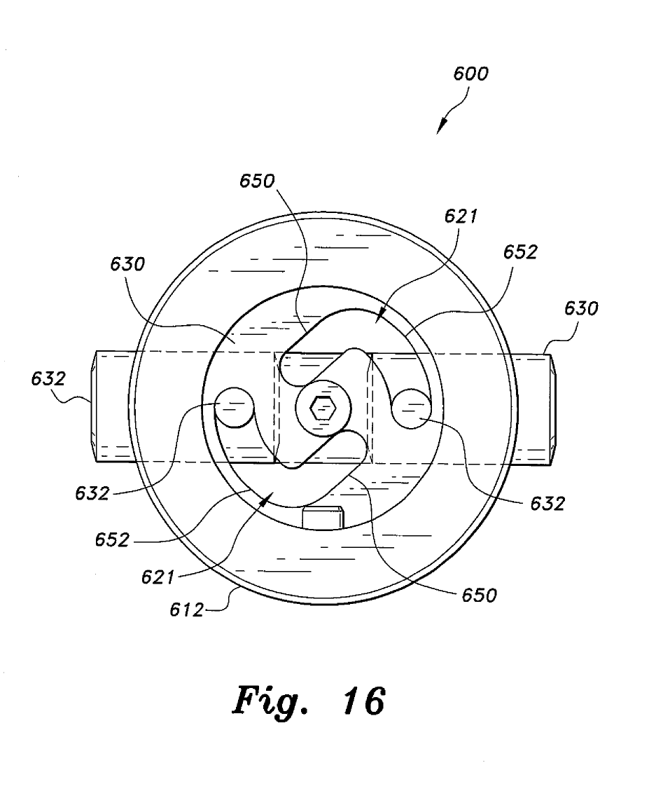

A still further alternative embodiment of a radially reciprocating lock 600 is shown in FIG. 16. In this embodiment, the radially reciprocating lock 600 includes a cam geometry that insures and maintains the locking geometry without external components, such as springs.

As shown, the radially reciprocating lock 600 includes a cylindrical housing 612, a pair of locking members 630 extendable into and out of the housing 612 between unlocked and locked positions respectively, a cam follower 632 attached to each locking member 630, a crank disk 628 and a pair of cam slots 621 facilitating slidable movement of the cam followers 632 upon rotation of the crank disk 628. In this embodiment, each cam slot 621 is curvilinear, rather than straight. Each cam slot 621 includes a straight, chordal section 650 and a curved section 652 concentric with the circumference of the crank disk 628. The chordal section 650 pushes and pulls the respective cam follower 632 between the locked and unlocked positions. However, the curved section 652 permits further rotation of the crank disk 628 to seat the cam follower 632 into the end of the curved section 652. In this position, the respective locking members 630 are effectively locked into the locked position, since the cam follower 632 cannot begin to slide into the retracted, unlocked position until the cam follower 632 has at least reached the juncture between the chordal section 650 and the curved section 652. Thus, this arrangement provides a self-locking function without the need of springs or other components, although they can be incorporated as redundant features.

It is to be noted that the radially reciprocating lock 10, 100, 200, 300, 400, 500, 600 encompasses a variety of alternatives. For example, the radially reciprocating lock can be constructed from various materials, such as plastic, metal, wood, composites and combinations thereof. The individual components can be machined or molded, and they can be provided in various colors or with indicia for easy identification. Additionally, any of the abovementioned cam slots 221, 331, 431, 521, 621 can be configured to have curved cam profiles or a combination of linear and curvilinear profiles to facilitate the desired movement of the respective locking members.

It is to be understood that the present invention is not limited to the embodiments described above, but encompasses any and all embodiments within the scope of the following claims.

We claim:

1. A radially reciprocating lock, comprising:
an elongate cylindrical housing having a hollow interior and at least one slot formed in the housing extending into the hollow interior;
a locking mechanism disposed in the hollow interior, the locking mechanism having:
an elongate, rotatable lock shaft extending axially inside the housing, the lock shaft having an axis of rotation;
a crank mechanism attached to the lock shaft; and
at least one radially reciprocating locking member operatively connected to the lock shaft, the at least one locking member being extendable out of the housing through the at least one slot in the housing into a locked position and retractable through the at least one slot in the housing into an unlocked position; and
at least one endcap attached to an axial end of the housing for covering and protecting the locking mechanism inside the housing, the at least one endcap having a center hole for passage of an end of the lock shaft.

2. The radially reciprocating lock according to claim 1, wherein said elongate cylindrical housing further comprises:
at least one bore formed thereon near an axial end, the at least one bore extending into the hollow interior, each said at least one endcap having a blind bore formed on an outer peripheral surface, the at least one bore on said cylindrical housing and the blind bore alignable with each other; and
a lock dowel insertably mounted through the at least one bore of said cylindrical housing and into the blind bore of said at least one endcap when the bores are aligned in order to secure and prevent rotational movement of said endcap relative to said cylindrical housing.

3. The radially reciprocating lock according to claim 1, wherein said lock shaft has a shaped recess formed on at least one end thereof, the shaped recess being adapted for selectively receiving a member for subsequent selective rotation of said lock shaft in order to turn said lock shaft between locked and unlocked positions.

4. The radially reciprocating lock according to claim 1, wherein said crank mechanism comprises:
a pair of spaced crank disks mounted coaxially along the length of said lock shaft, each of the crank disks having at least one bore formed in the crank disk at a radially offset position from said lock shaft, the at least one bore from one of the crank disks being in axial alignment with the at least one bore in the other crank disk;
at least one elongate crank pin mounted to a corresponding aligned pair of the at least one bore in the crank disks, the at least one elongate crank pin being parallel to said lock shaft; and
at least one crank member pivotally mounted on the at least one crank pin, said locking member also being pivotally mounted on the at least one crank pin;
wherein selective rotation of said lock shaft rotates the crank disks, thereby pivoting the at least one crank member and reciprocating said locking member to selectively extend or retract said locking member in the slot of said housing.

5. The radially reciprocating lock according to claim 1, wherein said crank mechanism comprises:
a crank disk mounted coaxially along the length of said lock shaft, the crank disk having at least a pair of cam slots, each of the slots extending at a chordal offset position from the axis of rotation of said lock shaft; and
a cam follower pivotally attached to said at least one radially reciprocating locking member, the cam follower riding inside a corresponding one of the cam slots;
wherein selective rotation of said lock shaft rotates the crank disk, thereby pivoting the cam follower to push and pull said at least one locking member into and out of the locked and unlocked positions.

6. The radially reciprocating lock according to claim 5, further comprising means for locking the locked and unlocked positions of said locking mechanism.

7. The radially reciprocating lock according to claim 6, wherein said means for locking the locked and unlocked positions of said locking mechanism comprises:
at least a pair of position-locking holes formed at angularly spaced, offset positions on said crank disk;
at least one lock hole formed in said at least one endcap, the at least one lock hole being aligned with one of the position-locking holes upon rotation of the crank disk into the locked and unlocked positions; and
a locking pin selectively inserted through the lock hole and the aligned position-locking hole, thereby positively maintaining relative position of said crank disk and preventing further rotation thereof in either direction.

8. The radially reciprocating lock according to claim 5, further comprising means for biasing said at least one radially reciprocating locking member into the locked position.

9. The radially reciprocating lock according to claim 8, wherein said means for biasing said at least one radially reciprocating locking member into the locked position comprises a stop post projecting from a face of said crank disk and a coil spring wrapped around a portion of said lock shaft, the coil spring normally biasing the locking member into the locked position, the coil spring having a pair of end extensions, one of the end extensions being braced against an interior wall of said cylindrical housing and the other end extension being braced against the stop post, selective turning of said lock shaft against the bias of the coil spring retracting said at least one radially reciprocating locking member into the unlocked position and subsequent release of torque biasing the at least one radially reciprocating locking member into the normally locked position.

10. The radially reciprocating lock according to claim 9, further comprising an enlarged head formed at an end of each said cam follower, the enlarged head preventing axial slip of said cam follower within a respective said cam slot.

11. The radially reciprocating lock according to claim 8, wherein said means for biasing said at least one radially reciprocating locking member into the locked position comprises at least one leaf spring mounted to said crank disk and at least one stop post mounted to an interior wall of said cylindrical housing, the at least one leaf spring normally biasing the locking member into the locked position, the at least one leaf spring having one end attached to said crank disk and an opposing, free end braced against the at least one stop post, selective turning of said lock shaft against the bias of the at least one leaf spring retracting said at least one radially reciprocating locking member into the unlocked position and subsequent release of torque biasing the at least one radially reciprocating locking member into the normally locked position.

12. The radially reciprocating lock according to claim 11, wherein said endcap has a face having a grooved section, the face facing the interior of said cylindrical housing, the grooved section having space for accommodating said at least one stop post when assembled.

13. The radially reciprocating lock according to claim 1, wherein said at least one radially reciprocating locking member comprises an elongate oblong block.

14. The radially reciprocating lock according to claim 1, wherein said at least one radially reciprocating locking member comprises an elongate cylindrical post.

15. A radially reciprocating lock, comprising:
an elongate cylindrical housing having a hollow interior, and having at least one locking member slot and an arcuate lever slot formed in the housing;
a locking mechanism disposed in the hollow interior, the locking mechanism having:
a crank mechanism having an externally accessible lever for turning the crank mechanism, the lever projecting through the arcuate lever slot;
at least one radially reciprocating locking member operatively connected to the crank mechanism, the at least one locking member being extendable out of the housing through the at least one locking member slot in the housing into a locked position and retractable through the at least one locking member slot in the housing into an unlocked position; and
at least one endcap attached to an axial end of the housing for covering and protecting the locking mechanism inside the housing.

16. The radially reciprocating lock according to claim 15, wherein said elongate cylindrical housing further comprises:
at least one bore formed thereon near an axial end, the at least one bore extending into the hollow interior, each said at least one endcap having a blind bore formed on an outer peripheral surface, the at least one bore on said cylindrical housing and the blind bore being alignable with each other; and
a lock dowel removably inserted through the at least one bore of said cylindrical housing and into the blind bore of said at least one endcap in order to secure and prevent rotational movement of said endcap relative to said cylindrical housing,

17. The radially reciprocating lock according to claim 15, wherein said crank mechanism comprises:
a crank disk mounted inside said elongate cylindrical housing and rotatable about a rotation axis, the crank disk having at least a pair of earn slots, each of the cam slots extending at a chordal offset position from the axis of rotation of the crank disk, said lever extending radially from the crank disk; and
a cam follower attached to said at least one radially reciprocating locking member, the cam follower riding inside a corresponding one of the cam slots;
wherein selective rotation of the crank disk with said lever actuates the cam follower to reciprocate the at least one locking member into and out of the locked and unlocked positions.

18. The radially reciprocating lock according to claim 17, wherein each said cam slot comprises a cam profile for self-locking of said at least one locking member into the locked position.

19. The radially reciprocating lock according to claim 18, wherein said cam profile comprises a chordal section and a contiguous curved section extending from an end of the chordal section, the curved section being concentric with the circumference of said crank disk.
